(19) United States
(12) Patent Application Publication
(10) Pub. No.: US 2014/0078752 A1
(43) Pub. Date: Mar. 20, 2014

(54) LAMP HOUSING, LUMINAIRE ELEMENT AND LUMINAIRE

(71) Applicant: OSRAM OPTO SEMICONDUCTORS GMBH, Regensburg (DE)

(72) Inventors: Christoph Gaerditz, Muenchen (DE); Dietmar Fissl, Stuttgart (DE)

(73) Assignee: OSRAM OPTO SEMICONDUCTORS GMBH, Regensburg (DE)

(21) Appl. No.: 13/984,035

(22) PCT Filed: Jan. 2, 2012
(86) PCT No.: PCT/EP2012/050004

§ 371 Date: Nov. 13, 2013

(30) Foreign Application Priority Data
Feb. 9, 2011 (DE) 102011003839.6

(51) Int. Cl. F21V 15/01

(52) U.S. Cl. CPC F21V 15/01
USPC 362/365

(57) ABSTRACT

A luminaire includes a luminaire housing element for holding a lamp housing, and a lamp housing for accommodating a flat lamp, wherein the lamp housing has a laterally projecting connecting element, and wherein the luminaire housing element has a recess in which the connecting element engages in a form-fitting manner and is fixed when the mechanical connection has been produced.

### RELATED APPLICATIONS

The present application is a national stage entry according to 35 U.S.C. §371 of PCT application No. PCT/EP2012/050004 filed on Jan. 2, 2012, which claims priority from German application No. 10 2011 003 839.6 filed on Feb. 9, 2011.

### TECHNICAL FIELD

Various embodiments relate to a lamp housing, a luminaire element and a luminaire.

### BACKGROUND

The development of modern light-emitting devices has opened up new possibilities for styling lamps.

A particular light-emitting device is the organic light-emitting diode (OLED). An OLED has an organic layer in the active layer in order to convert electrical energy into electromagnetic radiation. When contact between the OLED and a power source is made via the electrodes, different charge carrier types are injected into the organic layer. Positive charge carriers, also designated as holes, move from the anode toward the cathode through the organic layer, while electrons move through the organic layer from the cathode toward the anode. In the process, excitation states in the form of electron-hole pairs, what are known as excitons, are formed in the organic layer, which break down with the emission of electromagnetic radiation.

An OLED is distinguished in particular by the fact that particularly flat and large-area lamps can be provided therewith. The lamp can have a thickness of less than 2 mm, while it is able to emit light from an area from several cm² up to m².

It is desirable to transfer the low thickness of the lamp to a luminaire having the lamp. To this end, it should be possible for a lamp housing that is as thin as possible to be fixed stably to a luminaire housing element of the luminaire. The disclosure is based on the problem of providing an appropriate lamp housing, a lamp housing element and a corresponding luminaire.

### SUMMARY

One embodiment of the luminaire has a luminaire housing element for holding a lamp housing and a lamp housing for accommodating a flat lamp.

Ideally, the lamp housing is likewise a flat structure which is suitable to accommodate the flat lamp. The lamp housing may carry the lamp. However, it is likewise conceivable that the lamp housing is a constituent part of the lamp. The flat lamp is in particular a semiconductor light-emitting element, for example an OLED or a system including optical fibers and inorganic LEDs. The lamp housing may have a multilayer structure. For example, it may have between two plates, for example glass plates, between which the lamp may be arranged, for example in a floating manner. As a result of the provision of two transparent plates, two light outlet openings from the lamp housing may be provided, so that, for example, transparent lamps or lamps emitting in two directions can be used efficiently. It is also conceivable that one of the plates is configured to be reflective. As a result of the floating accommodation of the lamp, the latter is not exposed to any particular mechanical stresses, since pressure, flexing or shear is intercepted by the lamp housing. Thus, account is taken of mechanical protection of the lamp. This is particularly advantageous since, for example, an OLED frequently includes sensitive materials, such as glass or a thin film encapsulation or TFE.

The lamp housing has, for example, a plate-like or else a film-like structure. For instance, it has a longitudinal extent, its width being smaller than its length. Likewise, however, square, polygonal or rounded lamp housings are also conceivable. Typically, the lamp housing is only slightly thicker than the lamp. An OLED may have a thickness of less than 2 mm. As a result of a correspondingly thin lamp housing, it is thus possible for a very thin luminaire to be provided. Typically, the lamp housing at the thickest point is approximately 3 times as thick as the lamp, that is to say for example 6.5 mm in the case of a 2 mm thick lamp.

Advantageously, the lamp housing is electrically insulating, so that protection against contact is ensured. To this end, the lamp housing has, for example, an electrically insulating plastic. This leads to a further weight saving. Given an appropriate design/safeguard against contact, the use of metal, for example aluminum or steel, is at least equally possible.

The lamp housing has at least one laterally projecting connecting element. By means of this connecting element, the lamp housing can be connected mechanically to the luminaire housing element. For this purpose, the luminaire housing element has a recess, in which the connecting element engages in a form-fitting manner when the mechanical connection has been produced and, for example, is fixed by means of contact pressure, adhesive bonding or welding.

As a result of the form-fitting engagement of the connecting element in the recess and the subsequent fixing, it is in particular ensured that there is a high load-bearing ability in relation to tension and compression in the longitudinal direction, i.e. in the direction horizontal to a contact area between the lamp housing and the luminaire housing element. Likewise, as a result of the connecting element engaging in the recess, a high load-bearing ability of the connection in relation to flexural forces on the connecting element transversely with respect to the connecting direction is ensured. This may advantageously additionally be ensured by the provision of at least one further connecting element.

In relation to fixing the connecting element in the recess in the luminaire housing element, different precautions can be taken. Advantageously, the luminaire housing element has a lower shell, which includes the recess, and an upper shell for fixing to the lower shell. If the upper shell is fixed to the lower shell, it covers the recess and in this way holds the introduced connecting element in the recess. Advantageously, for this purpose the upper shell can be fixed to the lower shell by a connecting means in such a way that a portion of the area of the upper shell runs above the recess. The upper shell may be fixed to the lower shell by an extremely wide range of connecting means, for example by screwing, riveting, adhesives, welding or else latching means.

Alternatively or additionally, the connecting element can also be held in the recess by different means, such as for example by pressing, by a screw fixing or by adhesive bonding.

It is further possible that the upper shell also has a recess, which is likewise equipped to accommodate the connecting element, at least partly.

In various embodiments, the luminaire housing element and/or the lamp housing have/has a supply channel, through which the, for example, electric feed lines or control lines can be led from the luminaire housing element to the lamp in the lamp housing. If a plurality of connecting means are provided between the lamp housing and the luminaire housing element, the supply channel is provided between the connecting elements, in order to permit the most possible stress-free guidance of the lines.

Overall, in this way a mechanically solid and load-bearing connection between the luminaire housing element and the lamp housing, i.e. between a plurality of housing elements of the luminaire, is achieved. A modular system is provided, with which the external outline of the housing elements can be adapted in accordance with technical or aesthetic desires. For instance, in this way a plurality of lamps can be fixed to a base, or else a plurality of luminaire elements and a lamp, the flattest possible connection and nevertheless mechanically stable connection of the housing elements constantly being achieved.

The luminaire housing element can fulfill different functions. It may include, for example, fixing means for fixing the luminaire to a stand, to the wall or to the ceiling. Likewise, it may include an energy supply or else control electronics for the lamp. In some embodiments, the luminaire housing element includes at least one electronic component, in particular a ballast for the lamp. Furthermore, the luminaire housing element may also include further optical elements, for example additional lamps, such as LEDs. In any case, the luminaire housing element may have a plurality of recesses in order to accommodate a plurality of lamp housings. To this end, the luminaire housing element have the shape of a multiple node.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a schematic illustration of an exemplary embodiment of a luminaire;

FIG. 2 shows a schematic illustration of an exemplary embodiment of a lamp housing;

FIG. 3 shows a schematic illustration of a first exemplary embodiment of a lower shell of a luminaire housing element;

FIG. 4 shows a schematic illustration of a second exemplary embodiment of a lower shell of a luminaire housing element;

FIG. 5 shows a schematic illustration of an exemplary embodiment of an upper shell of a luminaire housing element;

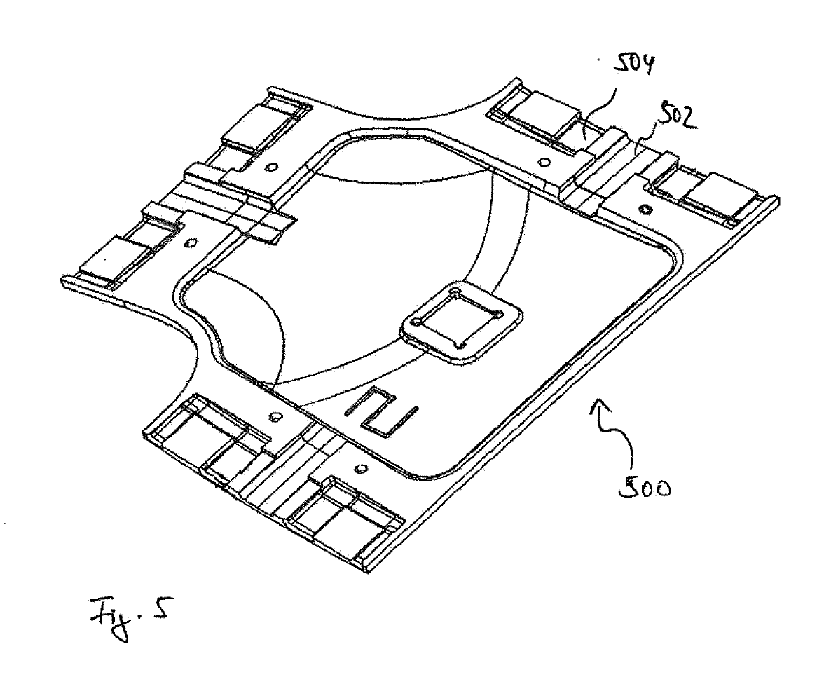

### DETAILED DESCRIPTION

The following detailed description refers to the accompanying drawing that show, by way of illustration, specific details and embodiments in which the disclosure may be practiced.

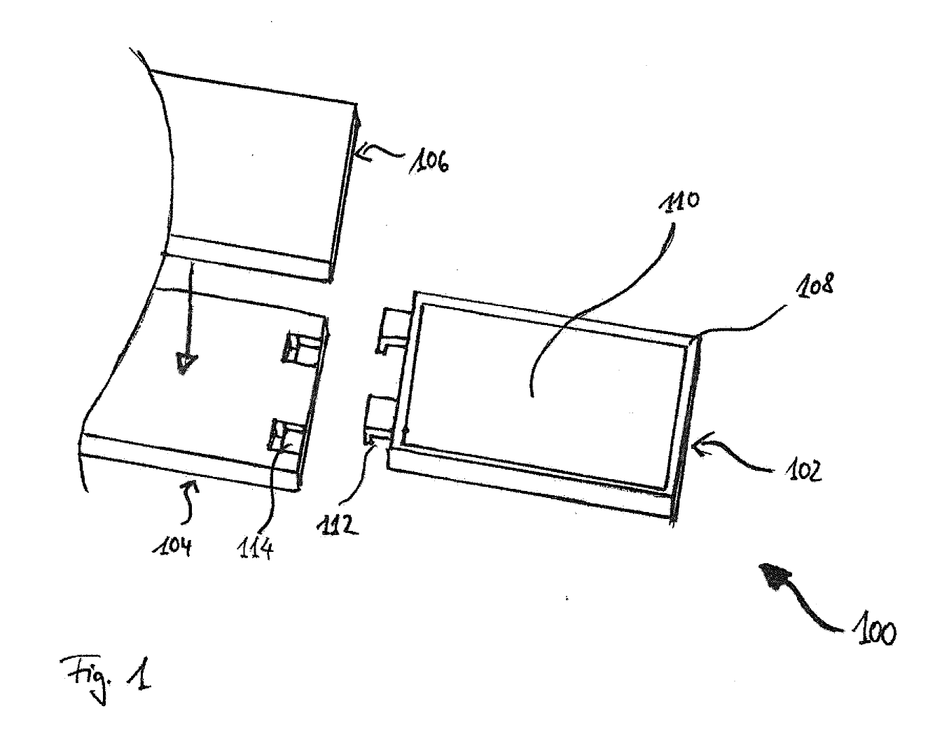

FIG. 1 shows a schematic illustration of a luminaire 100. The luminaire 100 is a modular system including a multiplicity of elements which, in order to simplify the illustration, are only partly illustrated. The luminaire 100 has a lamp housing 102 and a luminaire housing element. The luminaire housing element has a lower part 104 and an upper part 106. These are joined together in an operating state of the luminaire but, in FIG. 1, are illustrated separately in order to illustrate the connecting principle.

The lamp housing 102 has a frame 108 into which a flat lamp 110 is introduced. The lamp 110 is an OLED. However, it is likewise conceivable that another flat luminaire element, for example a system including a flat optical fiber with adjacent LEDs, is used as a lamp 110. The lamp 110 is introduced in a floating manner into the frame 108, so that it is largely decoupled from mechanical stresses in the luminaire 100, and/or in the luminaire housing. It is conceivable but not necessary that the lamp is covered on the front and rear side respectively by a plate, in order to be protected further. At least one of the plates is transparent in order to permit the emergence of light over a large area. If a transparent OLED is used as luminaire 110, it is advantageous to provide both plates of a transparent material in order, during operation of the lamp, to permit a two-sided emergence of light and a transparent impression of the lamp 110 as soon as the lamp 110 is switched off.

The lamp housing 102 also has a hook element 112. The hook element 112 is used for the mechanical connection of the lamp housing 102 to the luminaire housing element 104. For this purpose, the luminaire housing element 104 has a depression 114. The depression 114 is configured in such a way that the hook element 112 engages in a form-fitting manner. If the lamp housing 102 is connected to the luminaire housing element, the hook element 112 engages in the depression 114. The upper part 106 is connected firmly to the lower part 104, for example by screwing or by means of a latching connection. The upper part 106 therefore fixes the hook element 112 in the depression 114 by contact pressure. The connection between lamp housing 102 and luminaire housing element is mechanically stable and simultaneously ensures a flat configuration of the luminaire 100, the thickness of which is thus determined substantially by the thickness of the lamp 110.

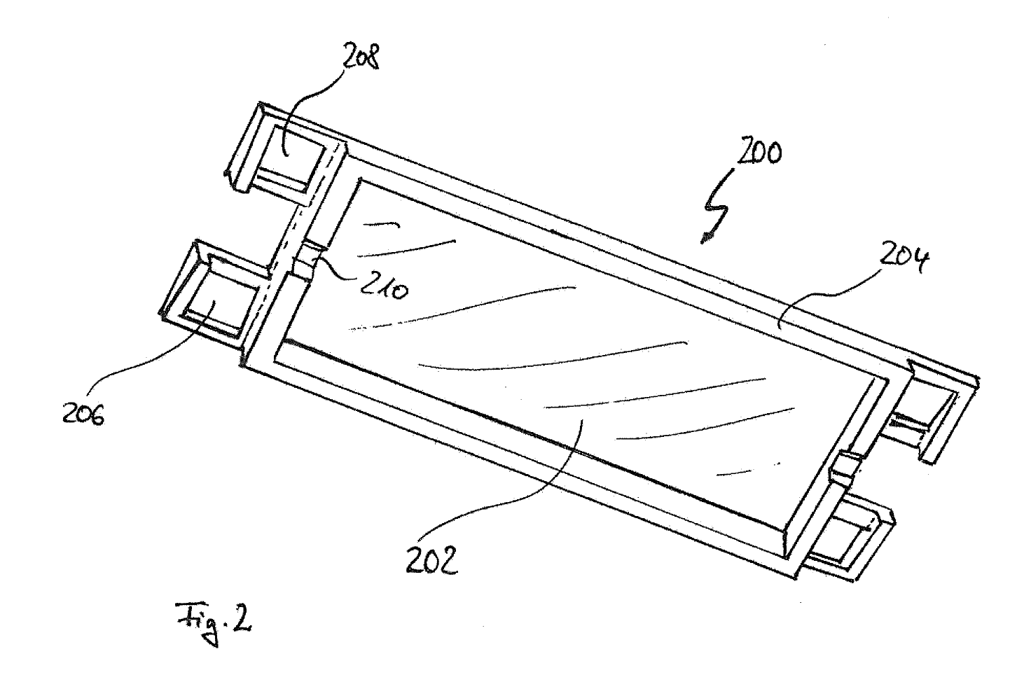

FIG. 2 shows a schematic illustration of an exemplary embodiment of a lamp housing 200. The lamp housing 200 has a central recess 202, which is bounded by a circumferential frame 204. However, likewise conceivable is also a frame running laterally, with the effect of a guide, into which the lamp can be slid. The boundary and on the side on which the hook element 112 is provided is provided by the luminaire housing element. It is also conceivable that the mechanical support of the lamp is carried out exclusively by one or more luminaire housing elements, so that the lamp housing 200 comprises the lamp but does not support the latter mechanically.

The recess 202 is bounded by a base plate. A flat lamp, such as an OLED, can be introduced into the recess 202. The recess 202 is dimensioned in such a way that it is able to accommodate the lamp. The lamp housing also has a first connecting means 206 and a second connecting means 208, by means of which the lamp housing 200 can be fixed to a luminaire housing element. Between the first connecting means 206 and the second connecting means 208, an opening 206 is provided in the frame 204, which is used as a supply channel for a lamp introduced into the recess 202. In order to fix the lamp, a cover plate, not illustrated, can be fitted to the frame and fixed, for example by means of screw fixing. Likewise conceivable is retention by means of a lateral guide or by means of a fixing in the recess by means of adhesive.

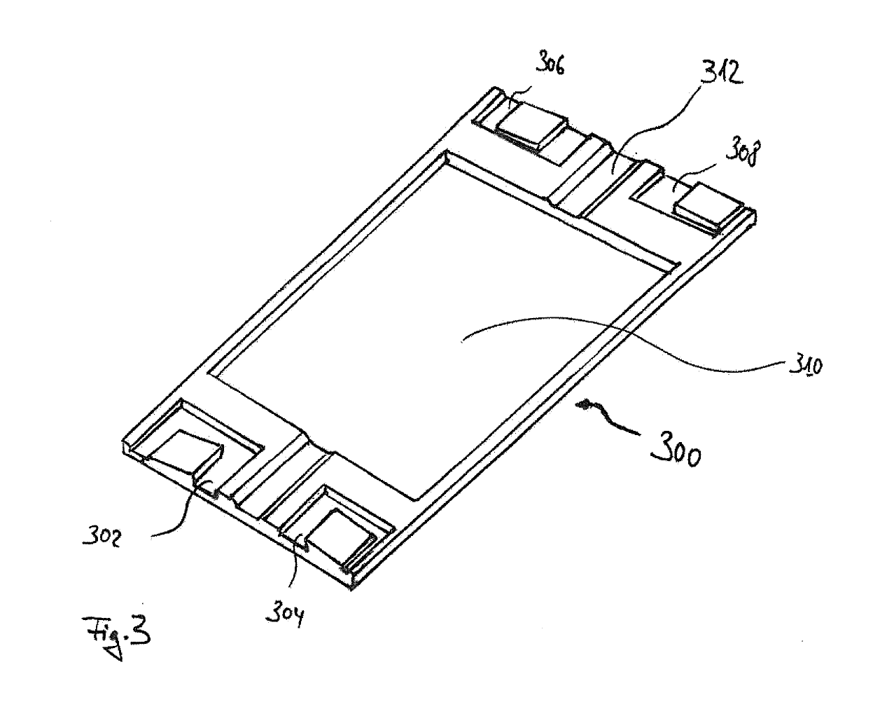

FIG. 3 shows a schematic illustration of a lower shell 300 of a luminaire housing element. The lower shell 300 is equipped in such a way that the lamp housing 200 from FIG. 2 can be fixed thereto. For this purpose, the lower shell 300 has recesses 302, 304, 306 and 308, which are arranged in pairs on opposite sides of the lower shell. The recesses 302, 304, 306 and 308 are configured in such a way that they are able to accommodate the first connecting means 206 and the second connecting means 208 in a form-fitting manner. By means of the pairs of recesses, a lamp housing 200 can be fitted respectively to each side of the lower shell.

Furthermore, the lower shell 300 has a cavity 310, into which, for example, electronics for supplying or driving a lamp can be introduced. The lower shell 300 has a supply channel 312, which is arranged between one of the pairs of recesses and is configured in such a way that it can attach directly to the supply channel 210 of the lamp housing. Via the supply channels, a supply or control line is thus able to connect the lamp to the electronics.

The lower shell 300 may be covered by a simple plate which, for example, is fixed to the lower shell 300 by screwing, pressing, welding, latching or adhesive bonding.

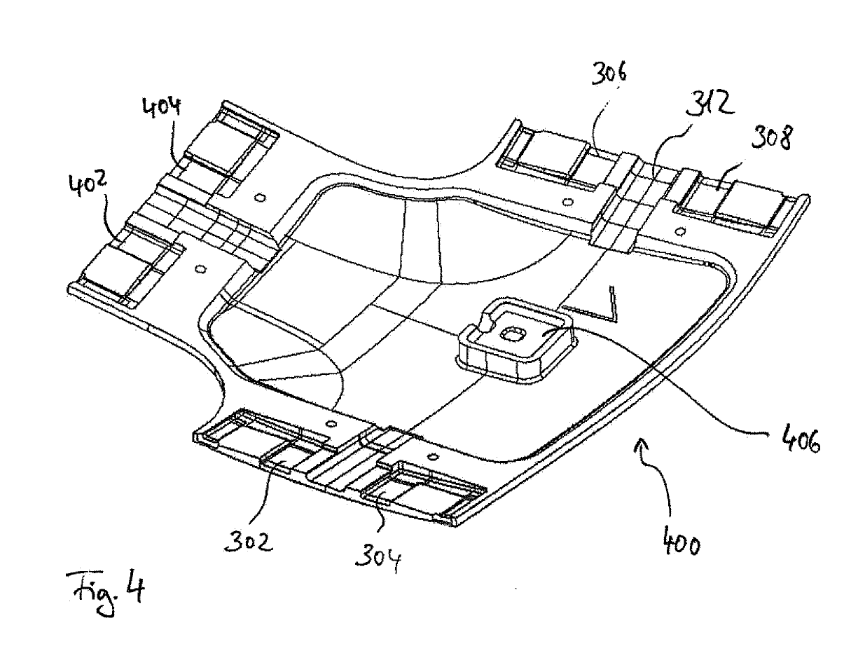

FIG. 4 and FIG. 6 show a lower shell 400 and an upper shell 500, respectively, of a second exemplary embodiment of a luminaire housing element. The lower shell 400 differs from the lower shell 300 in that an additional pair of recesses 402, 404 are provided. The luminaire housing element thus forms a type of T-piece, to which three lamp housings can be fixed. Furthermore, in the second exemplary embodiment, a fixing point is provided for an LED which radiates outward. In order to fix to a support, for example, or to a ceiling, additional openings are made in the shell for, for example, supporting cords or fixing elements.

As opposed to the exemplary embodiment described previously, the upper shell 500 and the lower shell 400 have a supply channel 502 and a recess 504, which correspond to a recess and a supply channel of the lower shell 400. Thus, when the upper shell 500 is attached to the lower shell 400, a common supply channel is formed from the supply channel 312 and the supply channel 502. The recess 504 rests on the recess 302 in order to form a common recess, in which the connecting means 208 can be anchored in a form-fitting manner.

While the disclosed embodiments has been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A luminaire comprising
a luminaire housing element for holding a lamp housing, and
a lamp housing for accommodating a flat lamp,
wherein the lamp housing has a laterally projecting connecting element, and
wherein the luminaire housing element has a recess in which the connecting element engages in a form-fitting manner and is fixed when the mechanical connection has been produced.

2. The luminaire as claimed in patent claim 1, wherein the flat lamp is an organic light-emitting diode.

3. A luminaire housing element for a luminaire as comprising:
a luminaire housing element for holding a lamp housing, and
a lamp housing for accommodating a flat lamp,
wherein the lamp housing has a laterally projecting connecting element,
wherein the luminaire housing element has a recess in which the connecting element engages in a form-fitting manner and is fixed when the mechanical connection has been produced, and
wherein the flat lamp is an organic light-emitting diode, comprising
a lower shell, which comprises the recess, and
an upper shell for fixing to the lower shell.

4. The luminaire housing element as claimed in patent claim 3, wherein the upper shell can be fixed to the lower shell by a connecting means in such a way that a portion of the area of the upper shell runs above the recess.

5. The luminaire housing element as claimed in patent claim 4, wherein the connecting means comprises at least one of the following elements:
a screw,
an adhesive or
a latching means.

6. The luminaire housing element as claimed in patent claim 3, which comprises an electronic component.

7. The luminaire housing element as claimed in patent claim 3, which comprises one or more additional lamps.

8. A lamp housing for a lamp as claimed in patent claim 1, which is configured in the form of a plate.

9. The lamp housing as claimed in patent claim 8, which has an outer frame.

10. The lamp housing as claimed in claim 8, which has a first connecting element and a second connecting element on one side.

11. The lamp housing as claimed in patent claim 10, in which, between the first connecting element and the second connecting element, there is arranged an opening.

12. The luminaire housing element as claimed in patent claim 3, which comprises a ballast for the lamp.

13. The luminaire housing element as claimed in patent claim 3, which comprises an inorganic light-emitting diode.

14. The lamp housing as claimed in patent claim 10, in which, between the first connecting element and the second connecting element, there is arranged a supply channel.
